(19) United States
(12) Patent Application Publication
(10) Pub. No.: US 2007/0097126 A1
(43) Pub. Date: May 3, 2007

(54) Method of transmutation of alpha-numeric characters shapes and data handling system

(76) Inventor: Viatcheslav Olchevski, POTOMAC FALLS, VA (US)

Correspondence Address: DYKAS, SHAVER & NIPPER, LLP, P.O. BOX 877, BOISE, ID, 83701-0877, US

(21) Appl. No.: 11/467,043

(22) Filed: Aug. 24, 2006

Related U.S. Application Data
(63) Continuation-in-part of application No. 10/917,818, filed on Aug. 14, 2004, now abandoned.
(60) Provisional application No. 60/537,371, filed on Jan. 16, 2004.

(51) Int. Cl. G06T 15/70

(52) U.S. Cl. 345/473

(57) ABSTRACT

A method for constructing of human readable animated alpha-numeric characters from a sequentially arranged graphical alpha-numeric characters shapes adaptable for processes by a data handling and transfer system is disclosed in this invention. The method includes the steps of: (a) defining a plurality of transmuted graphical shapes representing characters of the alpha-numeric text; (b) defining a plurality of binary bit patterns representing the plurality of transmuted graphical shapes; (c) constructing the machine readable binary code adaptable for processes by the data handling and transfer system by sequentially placing each of the binary bit patterns correspondent to each of the transmuted graphical shapes; (d) reconstructing the alpha-numeric text by presenting a stream of the transmuted graphical shapes that human operator is able to comprehend.

### CROSS-REFERENCE TO RELATED APPLICATIONS

This application is a continuation-in-part of Ser. No. 10/917,818, filed on Aug. 14, 2004, entitled “Method of transmutation of alpha-numeric characters shapes and the data handling system,” which was itself a non-provisional of provisional application 60/537,371, filed on Jan. 16, 2004, entitled “Method of displaying overlaid alpha-numeric characters in a time-sequenced manner,” the disclosures of which are incorporated by reference.

### FIELD OF INVENTION

This invention relates to encoding of alpha-numeric texts and more particularly to data handling and transmission systems that use a method of transmutation to generate graphical representation of the texts.

### BACKGROUND OF THE INVENTION

Humans recorded history is as old as the earliest found recording. Although, the earliest forms of recordings found were the pictograms cut into stone surfaces or clay tablets, hieroglyphs written on papyrus scrolls, and, much later, handwritings on silk or paper, they all were the embodiments of speech. Characters embodied sounds of speech. Words embodied objects of speech. To distinguish one word from another, the characters of a single word are, usually, connected together (See FIG. 1a) with blank spaces dividing words in a sentence.

Evidently, shapes of written characters evolved in such ways as to facilitate the ease and speed of handwriting. The difference between capital and lower case letters is just big enough to catch the attention of a reader and tell him that a new sentence begins or that a particular word represents a proper name. Although, a common notation exists, the individual differences between various hand writings sometimes make such texts hard to understand, yet the way the letters are connected turns the almost ineligible arabesques into concise statements.

Block lettering (FIG. 1b) slows the writing so considerably that it was almost unusable for private communications. Thus, this method was used only for works prepared for public reading. With the invention of the movable type, the block lettering turned into the most common way of reproduction of the written texts.

With the invention of digital indicators, pocket calculators and digital watches the art of writing entered a new era. Usually, such devices display a character at a time (usually a digit), to be replaced by another one, when necessary. In digital watches, for example, a number that represents minutes of the hour is changed every sixty (60) seconds and a number that represents seconds of the minute is changed every second. The transformation or replacement of the digit with next one happens almost instantly. It is said that one digit jumps another. It would not be difficult to output whole texts on said indicators one character at a time, although it didn't happen. It didn't happen on 7-segment diode or liquid crystal indicators and it didn't happen when the graphical displays came into being. When one character replaces another instantaneously, it would be difficult and stressful to pick out the words from a moving stream of jumping characters.

US Published Patent Application 20030159107 by Bederson et al. “Methods and systems for incrementally changing text representation” discloses a method and a system for incremental multi-level change of text and hints at the use of animation to further reduce the size of the text representation while still maintaining “a sense of continuity of identity.”

US Published Patent Application 20010049596 by Lavine et al. “Text to animation process” discloses a method for generating animated sequences from text strings that are conceptually related to said text strings.

U.S. Pat. No. 6,003,049 by Chiang. “Data handling and transmission systems employing binary bit-patterns based on a sequence of standard decomposed strokes of ideographic characters” suggests to represent “ideographic characters” by a sequence of strokes.

U.S. Pat. No. 5,706,398 by Assefa, et al. “Method and apparatus for compressing and decompressing voice signals, that includes a predetermined set of syllabic sounds capable of representing all possible syllabic sounds” discloses the use “frequency signature” to identify every pronounced syllable and store “associated binary code word closest to the spoken syllable.”

U.S. Pat. No. 4,845,645 by Matin, et al. “Sequential rapid communication visual displays” teaches that “[t]he invention operates by presenting individual, independent frames of information in rapid temporal succession to one small display window.”

U.S. Pat. No. 5,208,863 by Sakurai, et al. “Encoding method for syllables” discloses the use a “syllable classifying table” where “syllable is represented by an upper byte code indicating the consonant part of the syllable and a lower byte code indicating the non-consonant part of the syllable.”

While these patents/patent applications may be suitable for the particular purpose to which they address, they would not be as suitable for the purposes of the present invention as heretofore described.

### SUMMARY OF THE PRESENT INVENTION

One embodiment of the present invention is a system of encoding, transmitting and outputting alpha-numeric characters that uses a method of transmutation of the characters shapes. In the transmutation method, the adjacent characters of alpha-numeric text are replaced by a sequence of intermediate graphical shapes. When these shapes are displayed in an overlaid fashion, one after another, they create an animated (transmuted) image of the alpha-numeric text.

Particular embodiments of the present invention may show one or more of the following advantages.

The use of the transmutation method to output information, allows for the:
output of multiple streams of transmuted alpha-numeric characters on a single display, since the size of a single stream is equal to a size of a single character. It could be use to display, simultaneously and individually program schedules of a multitude of channels on a TV screen;
output of the stream of the size that is as large as the size of the display. It could be used on PDA devices to produce the output that could be read by visually challenged people. It could be used on outdoor electronic displays to display advertisements that could be visible from greater distances since the size of a single letter could be as large as display itself;
use of a minimum amount of space to display long alpha-numeric messages;
The method could be used in applications where the lack of space prevented any alpha-numeric output. For example, the digital graphical displays the size of a character could be placed inside analogue indicators of various aircraft's instruments to provide important information relevant to said instrument;
pre-cognition of the information where partially transmuted shape of the upcoming character carries information about the said character;
obtain the smoothness of the transition between digits that eases the strain on the eyes of the operator. The method could be used to replace any displays and indicators where digits jump (abruptly replace) one another;
improve cognition, in that presenting a text as a sequence of transmuted characters clearly shows the words boundaries; and/or
increase the reading speed.

The use of transmutation method for data encoding and transmission:
encrypts the information and makes it more prone to errors;
switches from alpha-numeric representation of information to a graphical representation;
Instead of encoding of individual alpha-numeric characters, the pairs of said characters are encoded. That considerably increases a number of encoded “units of information,” thus making this encoding method more difficult to break;
Every pair of alpha-numeric characters can be represented by an increased number of intermediate graphical shapes (5, 12, 24, etc) to increase the difficulty of breaking of the encoded message;
Deliberately loosing a number of intermediate graphical shapes in a random fashion will make the encoded message more difficult to break;
Inserting an additional message(s) inside the encoded message increases the difficulty of breaking of the said message;
Sending the encoded message by streaming, makes it more difficult to intercept the complete message; and/or
Since, the information, displayed by the method of transmutation, can only be cognized by a human at the instant of being displayed, it makes the method of transmutation suitable for applications, where the intended use of information is “for your eyes only.”

### BRIEF DESCRIPTION OF THE DRAWINGS

FIG. 1a Handwritten letters of the English alphabet.

FIG. 1b Block letters of the English alphabet.

FIG. 2a Samples of transmutations of the shapes of letters: “a” to “b”.

FIG. 2b Samples of transmutations of the shapes of letters: “C” to “d”.

FIG. 2c Samples of transmutations of the shapes of letters: “E” to “F”.

FIG. 3a Samples of transmutations of the shapes of numbers “1” to “2”.

FIG. 3b Samples of transmutations of the shapes of numbers “1” to “3”.

FIG. 3c Samples of transmutations of the shapes of numbers “1” to “4”.

FIG. 3d Samples of transmutations of the shapes of numbers “1” to “5”.

FIG. 3e Samples of transmutations of the shapes of numbers “1” to “6”.

FIG. 3f Samples of transmutations of the shapes of numbers “1” to “7”.

FIG. 3g Samples of transmutations of the shapes of numbers “1” to “8”.

FIG. 3h Samples of transmutations of the shapes of numbers “1” to “9”.

FIG. 4 Sample of an encoding table of the encoding software module with five intermediate graphical shapes per transmutation of an alpha-numeric character and corresponding randomly generated numbers of said shapes.

FIG. 5. Block diagram illustrating the components of data handling system, according to preferred embodiment of the present invention.

FIG. 6. Block diagram illustrating the components of data handling system, according to one embodiment of the invention.

FIG. 7. Sample of the transmutation of the word “QUICK”.

FIG. 8. Sample of the transmutation of the word “BROWN”.

FIG. 9. Sample of the transmutation of the word “FOX”.

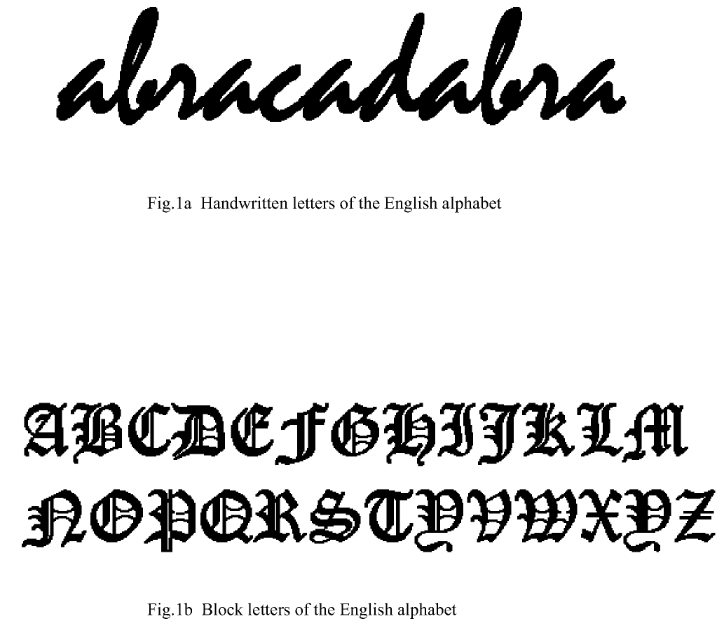

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provide so that this disclosure will be thorough and complete, and will fully convey the scope of the invention to those skilled in the art. Like numbers refer to like elements throughout.

The present invention seeks to address the aforementioned problems by providing a system and method that employs transmutation of the shapes of alpha-numeric characters as a way to “connect” the individual characters of a single word when displayed in overlaid fashion.

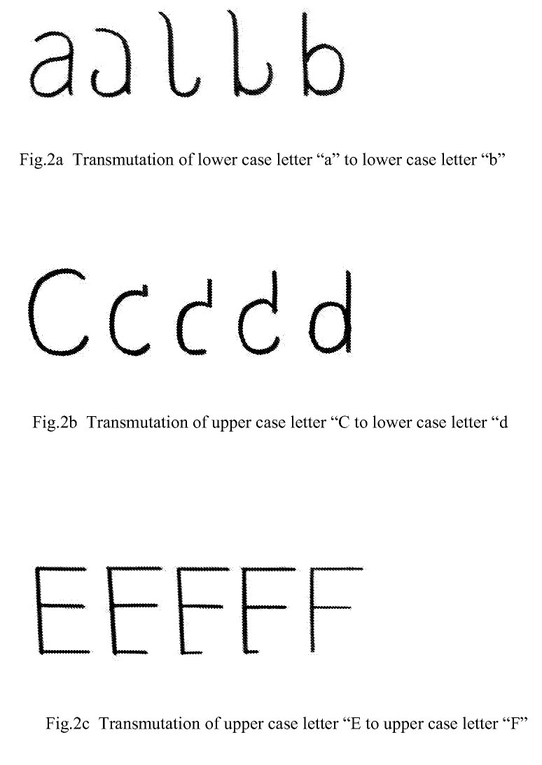

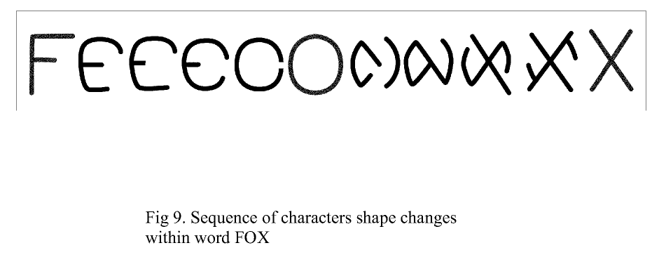

In the present invention's transmutation method, pairs of said characters are replaced by a multitude of intermediate graphical shapes. FIGS. 2a-c shows the transmutation of lower case letter “a” to lower case letter “b”, upper case letter “C” to lower case letter “d” and upper case letter “E” to upper case letter “F”. FIG. 7 showing the transmutation of the word QUICK (Q to U, U to I, I to C, C to K). FIG. 8 showing the transmutation of the word BROWN (B to R, R to O, O to W, W to N). FIG. 9 showing the transmutation of the word FOX (F to O, O to X).

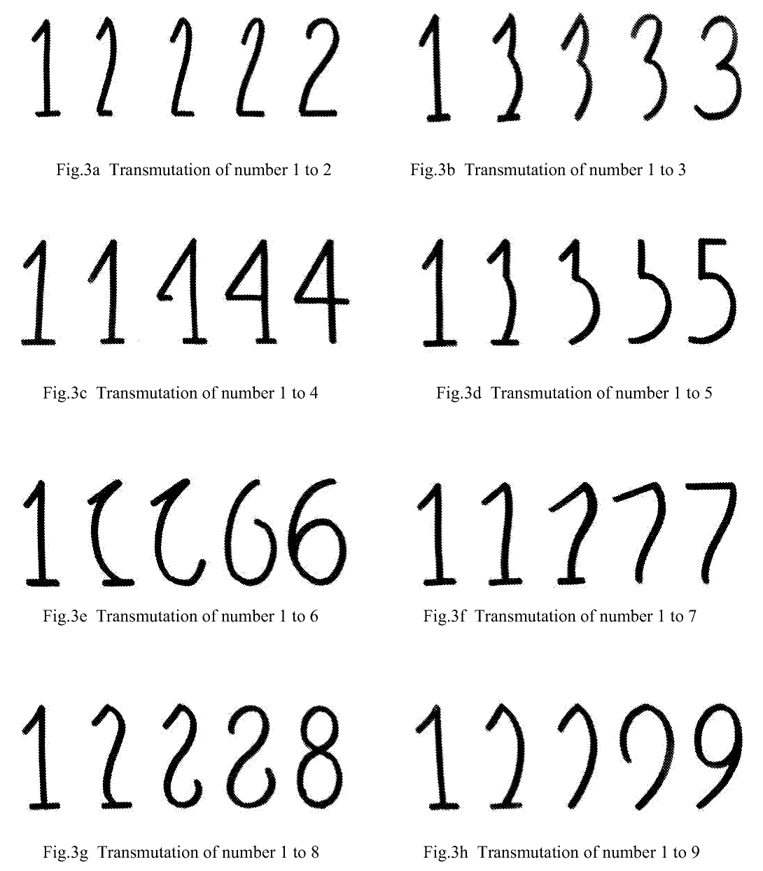

When these shapes are displayed in overlaid fashion, one after another, they create an animated (transmuted) image of the original alpha-numeric message. In order for the human mind to interpret the transmuted message as a smooth and uninterrupted process, sufficient number of intermediate graphical shapes needs to be displayed over a period of time (for example, twenty-four (24) shapes per second). The resulting effect is similar to the animation effect of the motion picture. During such animation, a person will see the characters smoothly transmuting (or changing, or turning, or morphing) into each other. The exceptions are starting characters of every word and all special characters. See FIGS. 3a-h that shows intermediate graphical shapes for transmutation of number “1” to numbers “2”, “3”, “4”, “5”, “6”, “7”, “8”, and “9”.

According to a preferred embodiment of the present invention, there is provided a system that generates a stream of said transmuted characters shapes, based on text retrieved from a data storage or, alternatively, based on text from interactive input and sends said stream to a display on at least one user interface.

One embodiment of the system and method of the present invention provides a capability to interface at least two said systems for communication purposes using a computer network.

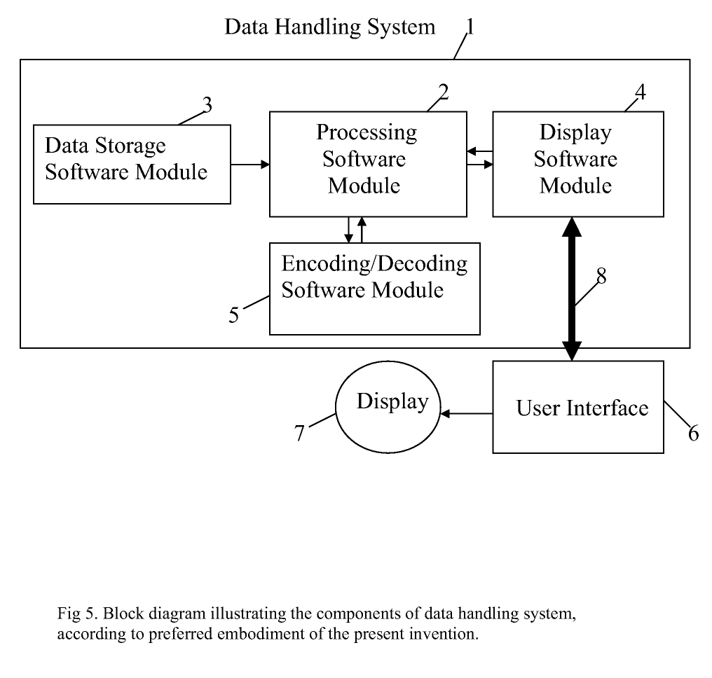

Referring now to the drawings, in particular to FIG. 5, there is illustrated a data handling system 1 configured as client/server architecture used in a preferred embodiment of the present invention. A “client” is a member of a class or group that uses the services of another class or group to which it is not related. In the context of a computer network, such as the Internet, a client is a process (i.e. roughly a program or task) that requests a service which is provided by another process, known as a server program. The client process uses the requested service without having to know any working details about the other server program or the server itself. In networked systems, a client process usually runs on a computer that accesses shared network resources provided by another computer running a corresponding server process. However, it should also be noted that it is possible for the client process and the server process to run on the same computer.

A “server” is typically a remote computer system that is accessible over a communications medium such as the Internet. The client process may be active in a second computer system, and communicate with the server process over a communications medium that allows multiple clients to take advantage of the information-processing capabilities of the server. Thus, the server essentially acts as an information provider for a computer network.

The block diagram of FIG. 5 therefore shows a data handling system 1 comprises a computer or microprocessor (not shown) operating as a “server.” Preferably, said system includes hardware (not shown) and associated software for data storage. In a preferred embodiment, the data handling system 1 consists of a data storage 3 electronically retaining information that is to be communicated to a user interface, a processing software module 2 interfacing with the data storage module 3, encoding software module 5, and being adapted to process the data retrieved based on predetermined parameters; a display software module 4 interfacing with the processing software module 2 and at least one user interface 6 and being adapted to display the processed data as a stream of overlaid transmuted graphical shapes on the display 7 of said user interface.

Although, there are one-hundred-twenty-eight (128) (or one half of ASCII character set) characters of any English font that could be used in a text, for practical reasons, in the preferred embodiment of the invention, only the following alpha-numeric characters are included: twenty-six (26) lower case English letters, twenty-six (26) upper case English letters, ten (10) special characters (+−., *:!@#$), ten (10) numbers (0 1 2 3 4 5 6 7 8 9) and a blank character. There are seventy-three (73) characters all together. The total number of possible unique combinations (pairs) of said characters is 2701, including transmutation of every character onto itself.

In the process of transmutation, every pair can be represented by a multitude of intermediate graphical shapes. In one embodiment of the invention, there are five (5) intermediate graphical shapes per transmutation chosen.

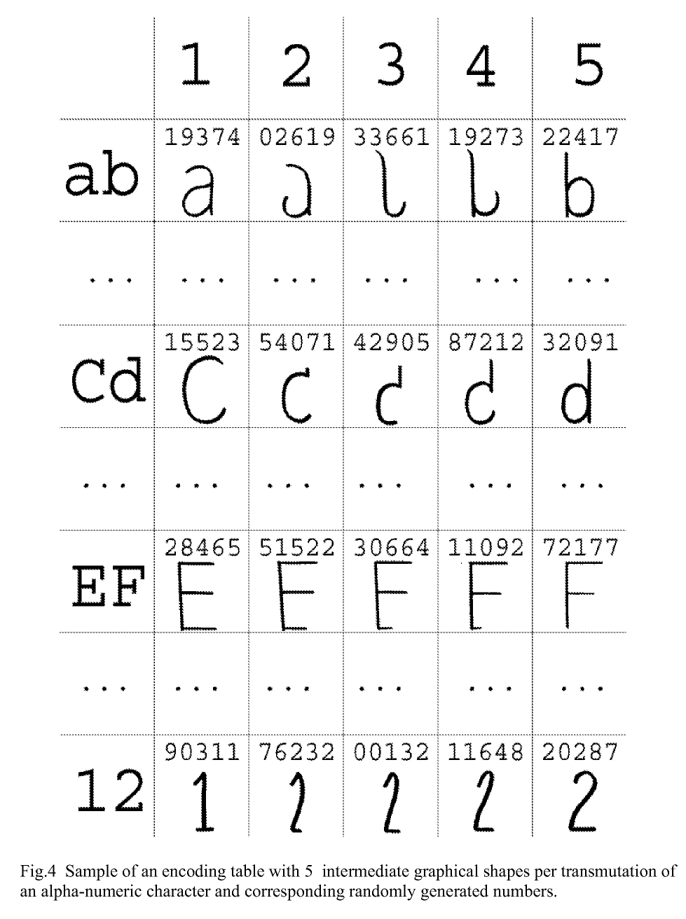

Every shape is assigned a unique randomly generated number. The numbers are used for transmission purposes when a message is to be sent to a remote computer. See FIG. 4 which shows a sample of the encoding table of said encoding software module 5. The purpose of having the numbers generated in a random fashion is to increase the difficulty in decoding of an encoded text by un-authorized parties. However, it should also be noted that it is possible to use specialized algorithms to generate a multitude of intermediate graphical shapes for every pair of characters of the input alpha-numeric text dynamically, instead of retrieving said shapes that are electronically stored in the encoding table.

The receiver and sender may have a multitude of said encoding tables and agree to use one or the other based on a certain algorithm or a rule to further complicate the decoding of the encoded text by un-authorized parties.

Thus, at least one embodiment of the present invention can be used to reduce the display space required to transfer real-time information to a viewer. For instance, that would be accomplished by presenting N data frames at one spatial location, thereby reducing the required space by a factor of 1/N. Further, the present invention (embodiments thereof) could be used to increase the rate of display, to a viewer, of information. This would be accomplished by reducing the viewer's scanning eye movements (saccades) used to access information by presenting the information character by character instead of presenting the information spatially separated.

The user interface 6 of the data handling system 1 preferably comprises a computer (not shown) operating under software control. The user interface 6 includes a display or monitor 7. The computer and display 7 are preferably adapted to support applications or software for generating complex graphics, i.e., the computer has sufficient memory and a processor with sufficient processing speed to process graphics output. However, it should also be noted that it is possible to use specialized hardware that is not required a stand-alone computer as a part of user interface.

The processing software module 2 preferably processes the data by performing the analysis of the input alpha-numeric data retrieved from data repository 3, splitting said data into pairs and retrieving corresponding intermediate graphical shapes by interfacing with encoding software module 5. Then, a portion of the output of the processing software module is sent to the display software module 4. The display software module 4 then communicates the stream of transmuted characters to the user interface 6 for presentation on the corresponding display or monitor 7 through a data link 8. The data link 8 can be either electrical or optical and can include, by way of example and not for purposes of limitation, a satellite or other wireless connection, the Internet or world wide web, a local area network or LAN, a wide area network or WAN, an Intranet, or an Extranet.

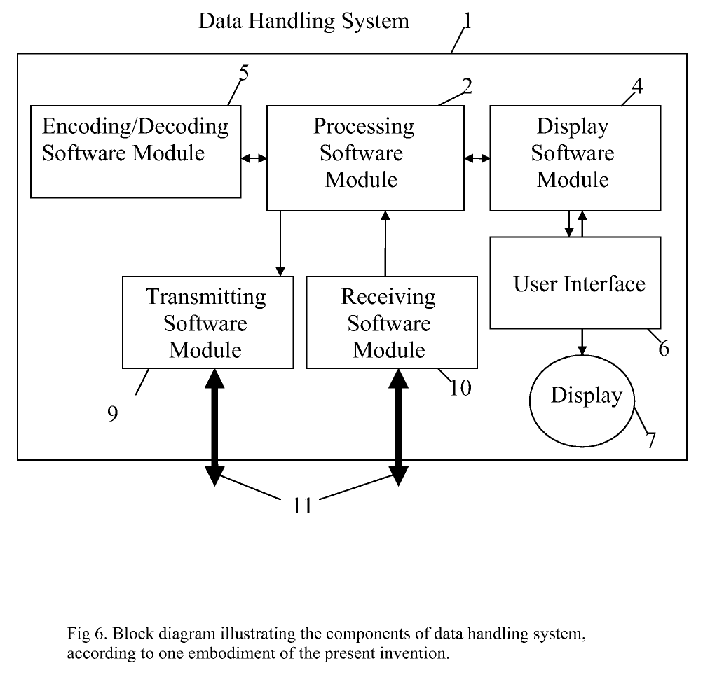

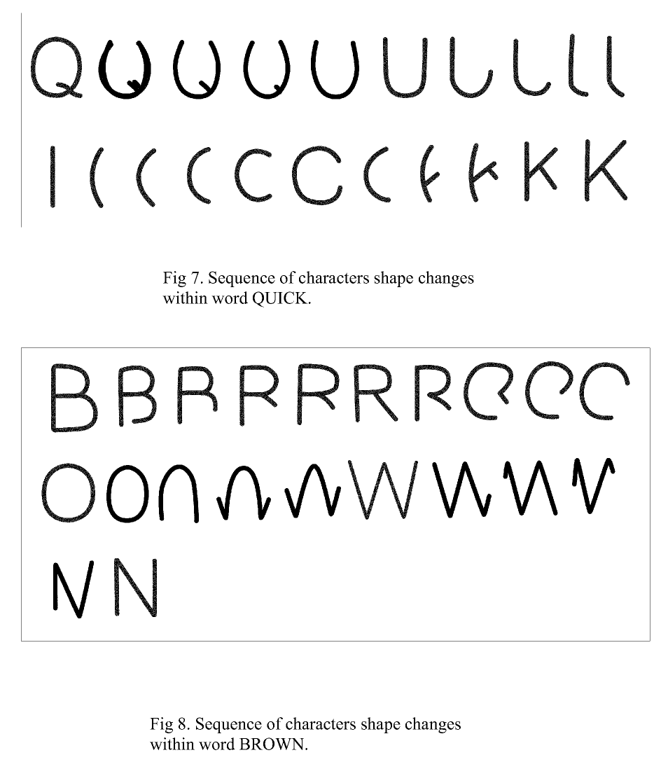

FIG. 6 is an example of a data handling system 1 modified for communication with other data handling systems(s) (not shown) used in one embodiment of the present invention. The transmitting software module 9 of the data handling system transmits the encoded information through a data link 11 and the receiving software module 10 of the data handling system receives the encoded information sent by another data handling system(s) through a data link 11 have been added to said system. The data link 11 can be either electrical or optical and can include, by way of example and not for purposes of limitation, a satellite or other wireless connection, the Internet or world wide web, a local area network or LAN, a wide area network or WAN, an Intranet, or an Extranet.

For the purposes of the communication with other data handling system(s) (not shown), the processing software module 2, interfacing with display software module 4, on performing said analysis of the input alpha-numeric information submitted by a user interface 6, retrieves corresponding binary numbers by interfacing with encoding software module 5 and sends at least a portion of the output to transmitting software module 9.

During the transmission, the transmitting software module 9 may drop certain binary numbers in a random or predetermined fashion, in order to further complicate the decoding of the encoded text by un-authorize parties. When the message is received by a receiving software module 10, decoded by a processing software module 2 and sent to a user interface 6, the lack of said dropped numbers/intermediate shapes will only slightly degrade the readability of the original text on display 7.

FIGS. 5 and 6 are block diagrams of example data handling systems according to the present invention. It will be understood that each block and combinations of blocks in these block diagrams can be implemented by computer program instructions. These computer program instructions may be loaded onto a computer or other programmable apparatus create means or devices for implementing the functions specified in the block diagrams. These computer program instructions may also be stored in a computer-readable memory that can direct a computer or other programmable apparatus to function in a particular manner, such that the instructions stored in the computer-readable memory produce an article of manufacture, including instruction means or devices which implement the functions specified in block diagrams. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagrams.

Accordingly, blocks or steps of the block diagrams support combinations of means or devices for performing the specified functions, combinations of steps for performing the specified functions and program instruction means or devices for performing the specified functions. It will also be understood that each block of the block diagrams and combinations of blocks in the block diagrams can be implemented by special purpose hardware-based computer systems which perform the specified functions or steps, or combination of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purpose of limitation.

I claim:

1. A method of transmutation of alpha-numeric characters, comprising: of splitting the alpha-numeric text into pairs of adjacent characters; replacing said pairs by a multitude of intermediate graphical shapes, where said shapes are formed, based on unique shapes of the starting and ending characters; displaying of said shapes in a cinematic/overlaid fashion to create an animation effect where said animation produces a dynamic graphical representation of said text.
